(19) United States
(12) Patent Application Publication
(10) Pub. No.: US 2009/0095329 A1
(43) Pub. Date: Apr. 16, 2009

(54) METHOD AND APPARATUS FOR CLEANING PARTS

(75) Inventor: Dan Walters, Bradenton, FL (US)

Correspondence Address: Emerson, Thomson & Bennett, LLC, 777 W. Market Street, Akron, OH, 44303, US

(73) Assignee: American Torch Tip Company, Bradenton, FL (US)

(21) Appl. No.: 12/248,358

(22) Filed: Oct. 9, 2008

Related U.S. Application Data
(60) Provisional application No. 60/978,455, filed on Oct. 9, 2007.

(51) Int. Cl. B08B 3/10; B08B 3/14

(52) U.S. Cl. 134/63

(57) ABSTRACT

The present invention includes embodiments that generally relate to a parts washer and methods for making and using the same. According to some embodiments a parts washer can include a plurality of cleaning stations arranged in series and adapted to automatically wash and transfer parts to the next cleaning station. Furthermore, in some embodiments the parts washer is adapted to minimize contact between a plurality of parts being washed. Some embodiments can include a rotatable cleaning station divided into substations and can include an aperture for transferring a part from the cleaning station to an adjacent cleaning station.

### CROSS-REFERENCE TO RELATED APPLICATIONS

This application claims priority to U.S. Provisional Patent Application Ser. No. 60/978,455 filed Oct. 9, 2007, now pending, which is incorporated herein by reference in its entirety.

### BACKGROUND OF THE INVENTION

A. Field of Invention

The present invention is directed generally to a method and apparatus for cleaning parts, and more specifically, to a method and apparatus including at least one cleansing station for at least partially removing matter deposited onto a part during fabrication.

B. Description of Related Art

Traditionally, metallic parts and parts machined from other solid materials in a fabrication facility are coated by grease, lubricants, grit and other such foreign matter utilized during the machining process to cool and form the parts. This foreign matter must be removed upon completion of the parts' fabrication to facilitate proper use of the parts. Removing the foreign matter can be time consuming. However, the longer each part is washed the more the part is exposed to damage from the washing process. Damage to the parts can compromise their integrity and make them unsuitable for applications with strict tolerances.

Many conventional parts washers are batch processes, washing the foreign matter from a large batch of parts distributed onto a holding tray at one time. Each tray is then typically placed within a cabinet and rotated relative to nozzles that inject a cleaning solution onto the parts. While being washed, however, the parts on the tray contact each other and introduce small dents, chips, and other such imperfections that can go unnoticed, allowing those damaged parts to enter the marketplace. Further, the batch processes require repeated loading and unloading of the parts to and from the trays, making the batch washing process time consuming and expensive.

Attempts to automate the batch washing processes include the use of horizontal drum washers. The drum washers enclose a rotatable auger within a cylindrical drum. Parts are introduced at one end of the drum and pushed through a cleansing solution disposed at the bottom of the drum by the rotation of the auger. Upon reaching the other end of the drum, the parts are ejected into a catch bin. While such processes eliminate the individual trays of the batch process, contact between the parts is even greater than in the batch processes, thereby causing greater damage to the parts during washing.

Accordingly, there is a need in the art for a parts washer that at least partially removes foreign matter deposited onto parts during fabrication of said parts and that reduces contact between the parts and reduces operator intervention once the washing process has commenced.

### SUMMARY OF THE INVENTION

An embodiment of the invention relates to a parts washer, comprising: at least one cleaning station, the cleaning station further comprising, a perimeter wall adapted to contain parts within the cleaning station, and defining a top open face and an opposing bottom open face, the top open face being adapted to receive parts from a source; at least one substation wall extending inwardly from the perimeter wall and defining a plurality of substations adapted to separately contain portions of parts, the at least one substation wall being adapted to move parts within the cleaning station; a central linkage adapted to receive and mate with a drive shaft in a fixed relation such that rotation of the drive shaft causes rotation of the perimeter wall and the at least one substation wall; and a bottom wall defining a stationary bottom of the cleaning station, the bottom wall being spaced apart from the bottom face of the perimeter wall to define a gap, the gap being adapted to retain parts within the cleaning station and allow fluids to flow out of the cleaning station, the back wall defining a hole comprising a parts exit port, wherein the parts exit port is adapted to allow parts contained within the cleaning station to exit one substation when the substation rotates into substantial alignment with the parts exit port; and at least one cleaning fluid port adapted to direct cleaning fluid onto at least a portion of the cleaning station.

Some embodiment may relate to a parts washer, comprising: a plurality of cleaning stations arranged in series, each cleaning station further comprising, a perimeter wall adapted to contain parts within the cleaning station, and defining a top open face and an opposing bottom open face, the top open face being adapted to receive parts from a source; at least one substation wall extending inwardly from the perimeter wall and defining a plurality of substations adapted to separately contain portions of parts, the at least one substation wall being adapted to move parts within the cleaning station; a central linkage adapted to receive and mate with a drive shaft in a fixed relation such that rotation of the drive shaft causes rotation of the perimeter wall and the at least one substation wall; and a bottom wall defining a stationary bottom of the cleaning station oriented at an oblique angle α relative to horizontal, the bottom wall being spaced apart from the bottom face of the perimeter wall to define a gap, the gap being adapted to retain parts within the cleaning station and allow fluids to flow out of the cleaning station, the back wall extending over substantially the entire perimeter of the bottom open face of the perimeter wall, the back wall defining a hole comprising a parts exit port, wherein the parts exit port is adapted to allow parts contained within the cleaning station to exit one substation when the substation rotates into substantial alignment with the parts exit port; and at least one cleaning fluid port adapted to direct cleaning fluid onto at least a portion of the cleaning station.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, embodiments of which will be described in detail in this specification and illustrated in the accompanying drawings which form a part hereof, and wherein:

FIG. 1 is a perspective view of a parts washer according to one embodiment.

FIG. 2 is a plan view of a cleaning station that is divided into a plurality of substations according to one embodiment.

FIG. 3 is a plan view of a bottom wall according to one embodiment.

FIG. 4 is a side view showing the position of the bottom wall of a cleaning station relative to the perimeter wall of a cleaning station according to an embodiment.

FIG. 5 is a plan view showing the position of the bottom wall of a cleaning station relative to the perimeter wall of a cleaning station according to an embodiment.

FIG. 6 is a side view showing a plurality of cleaning stations arranged in series according to an embodiment.

FIG. 7 is a flow diagram schematically illustrating the steps of a method for washing parts according to one embodiment.

### DETAILED DESCRIPTION OF THE INVENTION

The present invention is generally directed to devices and processes for cleaning fabricated parts, for instance, following a machining process. Some embodiments can comprise a parts washer having at least one rotatable cleaning station. In some embodiments, the parts washer can comprise a plurality of rotatable cleaning stations arranged in series so that a first station receives a part to be cleaned from a parts source, performs a cleaning step, and transfers the partially cleaned part to the next station. A last cleaning station can deposit a clean part in any appropriate receptacle. Any number of cleaning stations can be interposed in series between a first and last cleaning station.

According to some embodiments a cleaning station can comprise a perimeter wall having a first open face, an opposing second open face, and the perimeter wall can define a longitudinal axis perpendicular to the open faces. The perimeter wall can be regarded as an upper portion of the cleaning station. A cleaning station can also comprise a bottom wall spaced apart from an open face of the perimeter wall to define a gap. The perimeter and bottom walls can be spaced apart by any appropriate means while allowing the perimeter and bottom walls to rotate independently. The gap can be sized so that the cleaning station can retain parts disposed therein, while allowing cleaning fluids to drain through the gap. According to some embodiments, a cleaning station can comprise a plurality of adjacent substations. The substations can be defined by one or more longitudinally running substation walls that extend in a generally inward direction from an inward face of the perimeter wall toward a central hub region. In some embodiments the hub region can be adapted to receive, for example, a drive shaft for rotating the perimeter and substation walls. Additionally, the bottom wall can include an aperture that is adapted to align with a substation and allow the contents of the substation to drop from the cleaning station. Furthermore, a cleaning station can be oriented at an angle of about zero to 90 degrees relative to horizontal, and can be arranged in a generally horizontal or vertical overlapping pattern.

In some embodiments the perimeter wall and substation walls can form a single part, such as a molded part or machined part. In other embodiments the perimeter and substation walls can comprise an assembly joined by any appropriate means known to those of skill in the art. Additionally, the perimeter can have any appropriate shape. For instance, a circular or polygonal perimeter can be appropriate. Furthermore, the walls can comprise any of a wide variety of materials, provided they are substantially chemically inert to, and resistant to, the cleaning fluids and other chemicals that they contact during operation. Some appropriate materials include, without limitation, polyolefins such as polyethylene, and/or polypropylene, or high density polyethylene. Other materials can include, without limitation, tetrafluoroethylene, or metals such as aluminum, stainless steel, or any of a wide variety of known metals and alloys thereof.

In some embodiments the bottom wall can comprise any appropriate shape. For instance, a perimeter wall having a generally octagonal shape can have an octagonal bottom wall, and a circular perimeter wall can have a circular bottom wall. Furthermore, the bottom wall can comprise any of a wide variety of materials, provided they are substantially chemically inert to, and resistant to, the cleaning fluids and other chemicals that it contacts during operation. Some appropriate materials include, without limitation, polyolefins such as polyethylene, and/or polypropylene, or high density polyethylene. Other materials can include, without limitation, tetrafluoroethylene, or metals such as aluminum, stainless steel, or any of a wide variety of known metals and alloys thereof.

In some embodiments the upper portion of a cleaning station can be adapted to receive a means for rotating the upper portion about a longitudinal axis. For example, in some embodiments the central hub region the upper portion can be adapted to receive one or more of a drive shaft, an electric motor, a stepper motor, or a servo motor. Furthermore, the upper portion can receive the means for rotating at either open face, or both open faces. For instance, in some embodiments, the upper portion receives a drive shaft that runs through an aperture in the bottom wall and mates with the central hub region of the upper portion in a fixed relation. According to such embodiments, the aperture in the bottom wall may be spaced apart from the drive shaft to avoid contact, or may include radial bearings to allow the drive shaft to rotate independent of the bottom wall.

Further according to such embodiments, the drive shaft can be in mechanical driving communication with a motor disposed in any convenient position, such as, without limitation in the central hub region of the upper portion. In some embodiments the motor may be located apart from the hub region. Furthermore, some embodiments can include any of a variety of gears mechanically coupling the motor to the drive shaft. Still further, in embodiment that include a plurality of cleaning stations, a single motor can be used to drive each cleaning station using arrangements of gears known to those of skill in the art.

In some embodiments, one or more cleaning fluids are directed onto at least a portion of a cleaning station, or even the entire cleaning station. For example, some embodiment include one or more positionable cleaning fluid ports for delivering a cleaning fluid to a cleaning station or substation. Some embodiments can include a plurality of positionable cleaning fluid ports directed on to one or more of the substations. For instance, in some embodiments each substation may have a different port delivering a cleaning fluid, or a single substation may have more than one port for delivering the same or different cleaning fluids. In some embodiments the positionable cleaning fluid ports can be manually positioned before use and remain in the same position during use. In other embodiments, the ports may be automatically positioned before use or during use. One of skill in the art will recognize that a wide variety of fluidic arrangements can be appropriate.

Some embodiments also include one or more basins for receiving used cleaning fluid. Each cleaning station can have its own basin, or one or more cleaning stations can share a basin. The used cleaning fluid can be treated and/or recycled. For instance, solids can be allowed to settle out in the basin, and the liquid can be drawn back into the cleaning fluid stream. Further, some embodiments can allow liquids to phase separate and may be adapted to remove one or more waste layers from the basin, or select a particular layer to collect for recycling. Still other embodiments can include any of a wide variety of means for treating the used cleaning fluid such as, without limitation skimmers, filters, drains, valves, spargers, adsorbents, and/or catalysts.

Optionally, some embodiments can include a means for transferring parts into a cleaning station and/or substation. For instance, some embodiments include a conveyor belt for delivering parts from a machine, such as a computer numerical control machine (i.e. CNC), to a cleaning station at a predetermined rate. In other embodiments a means for transferring parts can comprise a turn table, an articulated arm, a robotic arm, a CNC machine, a vacuum arm, or any of a wide variety of transfer means known in the art. In some embodiments, the means for transferring parts can be adapted to deliver a single part to each substation of a cleaning station.

According to some embodiments a parts washer can be adapted to use one or more of a wide variety of cleaning fluids. For example, the cleaning fluid can comprise one or more of benzene, toluene, xylenes, aniline, hexanes, methylene chloride, chloroform, carbon tetrachloride, tetrahydrofuran, dimethyl sulfoxide, N-methyl pyrrolidone, water, aqueous detergent, nitrogen, argon or air. In some embodiments it can be advantageous to use one or more cleaning fluids in a predetermined order to effect an efficient cleaning.

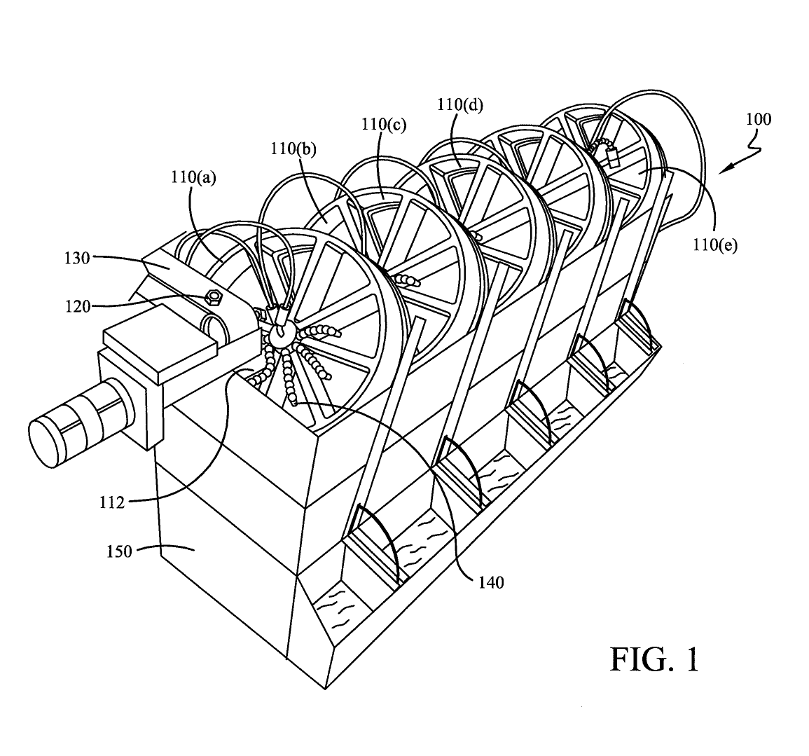

Referring now to the drawings wherein the showings are for purposes of illustrating embodiments of the invention only and not for purposes of limiting the same, FIG. 1 is a perspective view drawing of a parts washer 100 according to one embodiment. According to this embodiment, the parts washer 100 includes a series of five wash stations 110(a), 110(b), 110(c), 110(d), and 110(e). A first wash station 110(a) receives a part 120, which is transferred to the wash station 110(a) by a conveyor belt 130. The part 120 drops into a substation 112 and receives cleaning fluid from each of several adjustable nozzles 140 as the substation 112 rotates about a central axis. When the substation 112 aligns with an aperture in the bottom wall the part 120 falls through the aperture and into a substation in the next cleaning station 110(b). Further according to the embodiment in FIG. 1, the cleaning stations 110(a), 110(b), 110(c), 110(d), and 110(e) are positioned over a basin 150 that catches the used cleaning fluids.

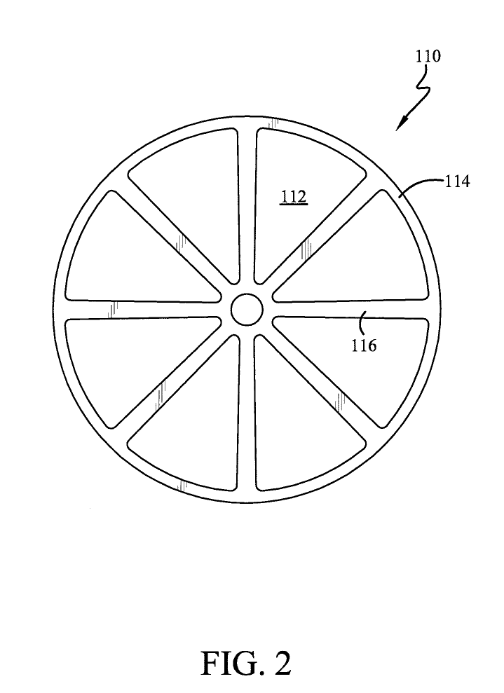

FIG. 2 is a plan view drawing of a part of a cleaning station according to one embodiment. According to FIG. 2 a cleaning station can include a perimeter wall 114 defining a circular shape. The perimeter wall is bisected by a plurality of substation walls 116, which extend inward toward a central hub 118. The central hub 118 can receive, for instance, a drive shaft in a fixed relation adapted to rotate the cleaning station 110 a central axis defined by the hub 118. The particular cleaning station 110 in the illustrated embodiment has eight substations 112. However, any number of substations 112 can be appropriate depending on the particular application. According to this embodiment the perimeter wall 114, substation walls 116 and hub 118 are all portions of a single part, such as a molded plastic part.

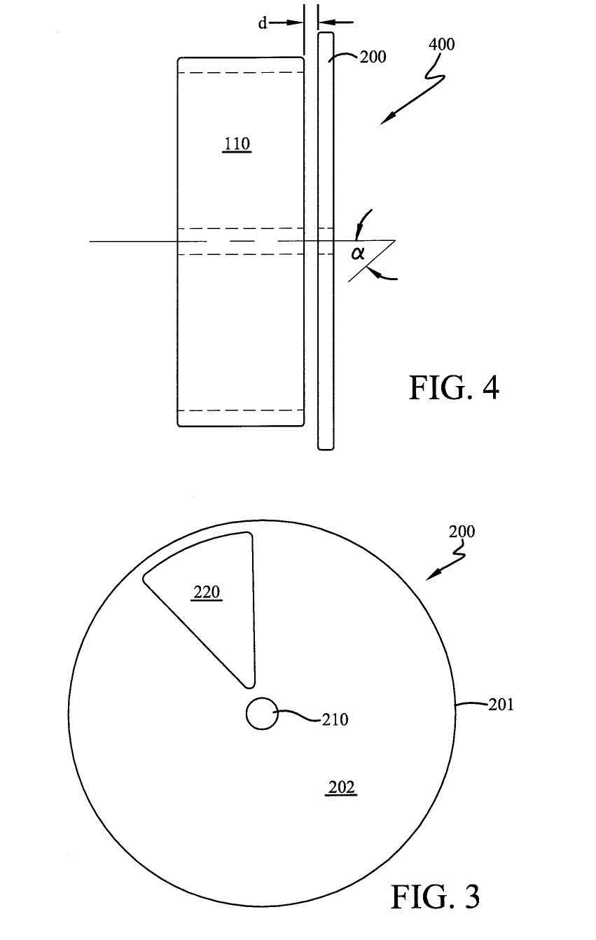

FIG. 3 is a plan view drawing of a bottom wall 200 for a cleaning station 110 similar to the one shown in FIG. 2. The bottom wall 200 defines a circular perimeter 201 and has a substantially solid face 202 with the exception of a hub 210, and an aperture 220. The hub 210 is adapted to receive, for instance, a drive shaft in a movable relation. For instance, in some embodiments, the drive shaft does not touch the sides of the hub 210. Therefore, movement of the drive shaft does not result in movement of the bottom wall 200. The aperture 220 is characterized by dimensions similar to that of a substation 112. Accordingly, the aperture is adapted to align with a substation 112 and provide a means for allowing the contents of a substation 112 to exit the substation 112.

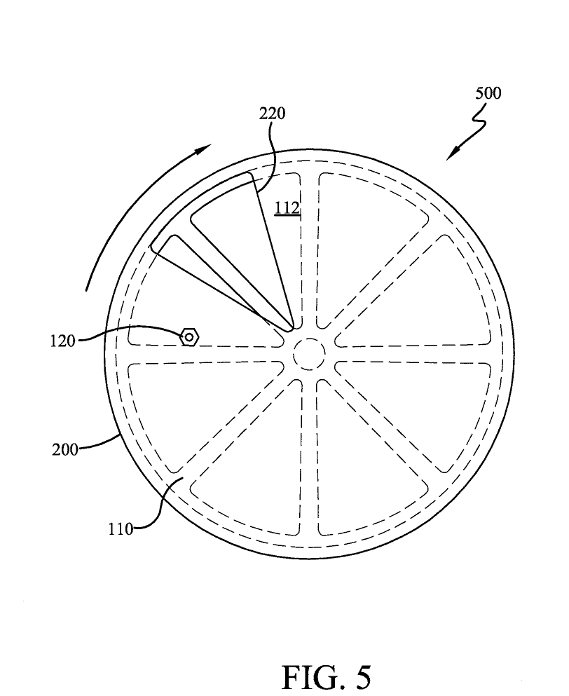

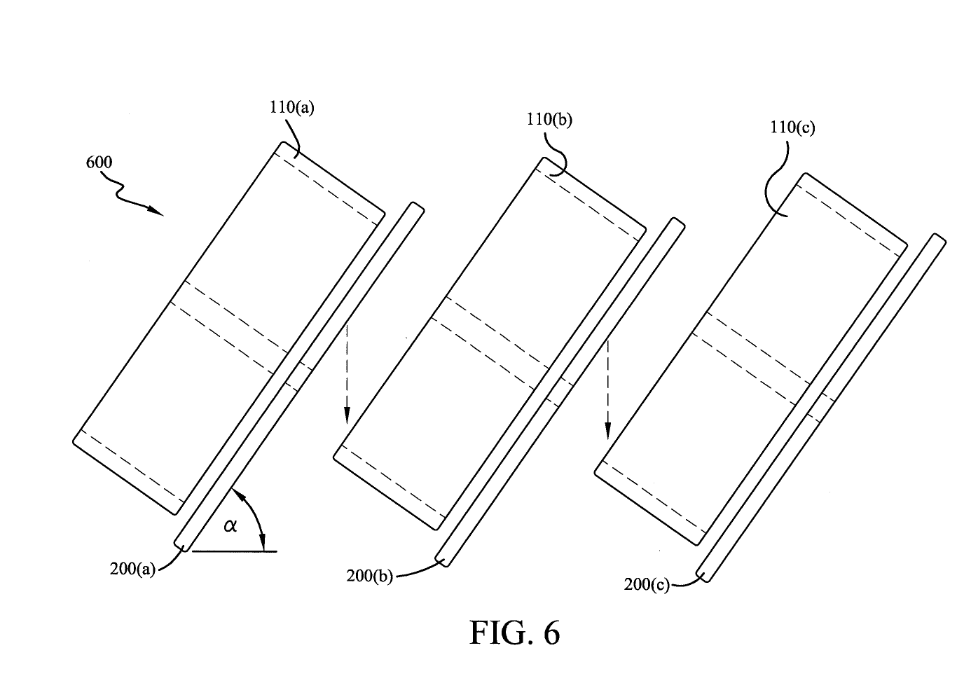

FIG. 4 is a side view drawing showing the relative positions of the cleaning station 110 and bottom wall 200 according to one embodiment. According to this embodiment the bottom wall 200 is spaced apart from the cleaning station 110 by a distance “d,” defining a gap. The gap creates flow path for cleaning fluids to exit the cleaning station 110. FIG. 5 is a plan view drawing of a cleaning station assembly 500 comprising a cleaning station 110, and a bottom wall 200. An aperture 220 in the bottom wall is shown partially aligned with a substation 112. A part 120 is shown disposed in another substation 112. FIG. 6 shows a plurality of cleaning stations arranged in series 600. The cleaning stations are oriented at an angle α relative to horizontal. Due to the angular orientation, a part 120 disposed in a substation 112 falls out of the substation 112 when the substation 112 aligns with the aperture 220. The part 120 lands either in a substation 112 of the next cleaning station 110 in the series, or in a final receptacle.

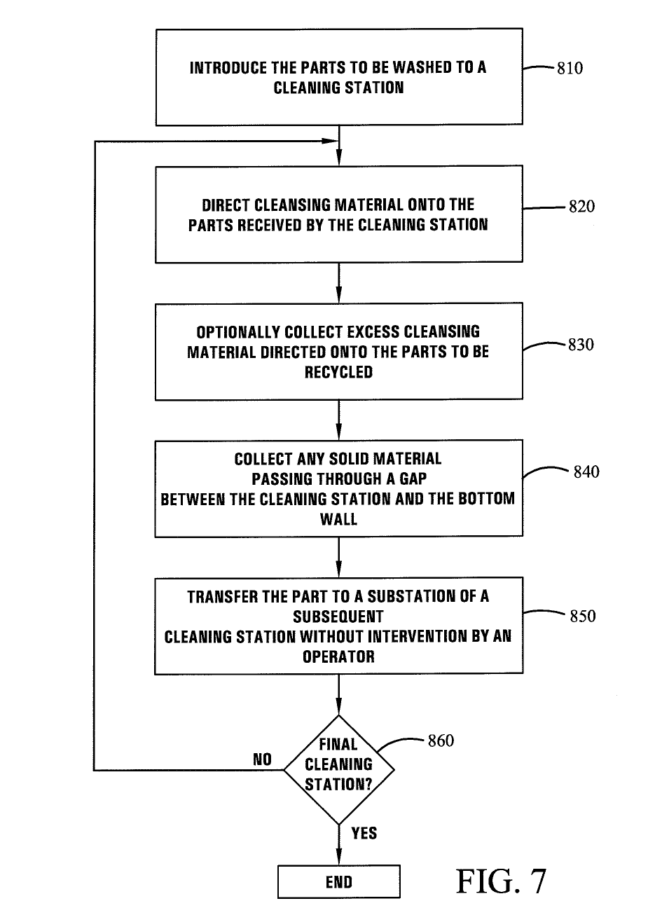

FIG. 7 is a flow chart showing a process according to an embodiment of the invention. According to this embodiment a part is introduced to the cleaning station in step 810. Cleaning fluid is directed onto the part in step 820. Optionally, cleaning fluid can be collected and recycled in step 830. In step 840 solids care collected. In step 850 the part is either transferred to the next cleaning station and the process loops back to step 820, or the part is transferred to a final receptacle and the process ends.

Illustrative embodiments have been described, hereinabove. It will be apparent to those skilled in the art that the above devices and methods may incorporate changes and modifications without departing from the general scope of this invention. It is intended to include all such modifications and alterations in so far as they come within the scope of the appended claims.

Having thus described the invention, it is now claimed:

We/I claim:

1. A parts washer, comprising:
at least one cleaning station, the cleaning station further comprising,
a perimeter wall adapted to contain parts within the cleaning station, and defining a top open face and an opposing bottom open face, the top open face being adapted to receive parts from a source;
at least one substation wall extending inwardly from the perimeter wall and defining a plurality of substations adapted to separately contain portions of parts, the at least one substation wall being adapted to move parts within the cleaning station;
a central linkage adapted to receive and mate with a drive shaft in a fixed relation such that rotation of the drive shaft causes rotation of the perimeter wall and the at least one substation wall; and
a bottom wall defining a stationary bottom of the cleaning station, the bottom wall being spaced apart from the bottom face of the perimeter wall to define a gap, the gap being adapted to retain parts within the cleaning station and allow fluids to flow out of the cleaning station, the back wall defining a hole comprising a parts exit port, wherein the parts exit port is adapted to allow parts contained within the cleaning station to exit one substation when the substation rotates into substantial alignment with the parts exit port; and
at least one cleaning fluid port adapted to direct cleaning fluid onto at least a portion of the cleaning station.

2. The parts washer of claim 1, wherein the cleaning station is adapted to operate at an oblique angle “α” relative to horizontal, and wherein the top open face of the rotatable cleaning station is directed in a generally upward direction.

3. The parts washer of claim 2, wherein angle α is from about zero to about 90 degrees.

4. The parts washer of claim 1, wherein the perimeter wall defines a generally circular perimeter.

5. The parts washer of claim 1, wherein the at least one substation wall comprises a plurality of substation walls extending inwardly from the perimeter wall and joining at a central hub region, the plurality of substation walls defining substations having approximately equal dimensions.

6. The parts washer of claim 5, wherein the plurality of substation walls extend approximately from the bottom open face to the top open face of the perimeter wall.

7. The parts washer of claim 1, wherein the bottom wall extends over substantially the entire perimeter of the bottom open face of the perimeter wall.

8. The parts washer of claim 1, wherein the parts exit port defines a perimeter that substantially coincides with the entire perimeter of one substation.

9. The parts washer of claim 1, wherein the bottom wall defines a central hole for receiving a drive shaft and allowing the drive shaft to mate with a central linkage, wherein the bottom wall remain stationary as the drive shaft rotates.

10. The parts washer of claim 1, wherein the parts source comprises one or more of a computer numerical control machine, a conveyor belt, or a robotic arm.

11. The parts washer of claim 1, further comprising a plurality of cleaning stations arranged in series, wherein the first cleaning station is adapted to receive parts from the parts source and wherein each subsequent cleaning station is adapted to receive parts from the parts exit port of the preceding cleaning station.

12. The parts washer of claim 11, wherein the last cleaning station is adapted to deposit clean parts into a receiving vessel.

13. The parts washer of claim 11, wherein each cleaning station is adapted to receive cleaning fluid from at least one cleaning fluid port.

14. The parts washer of claim 11, wherein each of the plurality of cleaning stations is adapted to receive a different cleaning fluid.

15. The parts washer of claim 1, wherein the cleaning fluid can comprise one or more of benzene, toluene, xylenes, aniline, hexanes, methylene chloride, chloroform, carbon tetrachloride, tetrahydrofuran, dimethyl sulfoxide, N-methyl pyrrolidone, water, aqueous detergent, nitrogen, argon or air.

16. The parts washer of claim 11, wherein used cleaning fluid from each cleaning station is separately collected.

17. The parts washer of claim 16, wherein at least a portion of the cleaning fluid is treated and recycled.

18. The parts washer of claim 17, further comprising a skimmer, a filter, or a drain.

19. A parts washer, comprising:
a plurality of cleaning stations arranged in series, each cleaning station further comprising,
a perimeter wall adapted to contain parts within the cleaning station, and defining a top open face and an opposing bottom open face, the top open face being adapted to receive parts from a source;
at least one substation wall extending inwardly from the perimeter wall and defining a plurality of substations adapted to separately contain portions of parts, the at least one substation wall being adapted to move parts within the cleaning station;
a central linkage adapted to receive and mate with a drive shaft in a fixed relation such that rotation of the drive shaft causes rotation of the perimeter wall and the at least one substation wall; and
a bottom wall defining a stationary bottom of the cleaning station oriented at an oblique angle α relative to horizontal, the bottom wall being spaced apart from the bottom face of the perimeter wall to define a gap, the gap being adapted to retain parts within the cleaning station and allow fluids to flow out of the cleaning station, the back wall extending over substantially the entire perimeter of the bottom open face of the perimeter wall, the back wall defining a hole comprising a parts exit port, wherein the parts exit port is adapted to allow parts contained within the cleaning station to exit one substation when the substation rotates into substantial alignment with the parts exit port; and
at least one cleaning fluid port adapted to direct cleaning fluid onto at least a portion of the cleaning station.

20. The parts washer of claim 19, wherein angle α is from about zero to about 90 degrees.
